(19) United States
(12) Patent Application Publication
(10) Pub. No.: US 2021/0311991 A1
(43) Pub. Date: Oct. 7, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Yuta NAKAMORI, Tokyo (JP); Kengo TOKUCHI, Kanagawa (JP)

(73) Assignee: FUJIFILM Business Innovation Corp., Tokyo (JP)

(21) Appl. No.: 17/093,653

(22) Filed: Nov. 10, 2020

(30) Foreign Application Priority Data
Apr. 7, 2020 (JP) 2020-069239

(51) Int. Cl. G06F 16/81; G06T 17/00

(52) U.S. Cl. CPC G06F 16/81; G06T 17/00

(57) ABSTRACT

An information processing apparatus includes a processor configured to store three-dimensional data in association with structured information in which pieces of information are structured, the three-dimensional data enabling a three-dimensional object created in virtual space to be output as a three-dimensional object in real space, output the three-dimensional data, which is stored, to an apparatus in real space, the apparatus being capable of outputting the three-dimensional object in real space, acquire real-life data regarding the three-dimensional object in real space after the three-dimensional data is output to the apparatus, and incorporate the real-life data regarding the three-dimensional data into the structured information.

### CROSS-REFERENCE TO RELATED APPLICATIONS

This application is based on and claims priority under 35 USC 119 from Japanese Patent Application No. 2020-069239 filed Apr. 7, 2020.

### BACKGROUND

### (i) Technical Field

The present disclosure relates to an information processing apparatus and a non-transitory computer readable medium.

### (ii) Related Art

Japanese Unexamined Patent Application Publication No. 2011-014108 discloses a space-integration control system including a real-space information control system that controls information in real space, a virtual-space information control system that controls information in virtual space, and an identifier assigning unit that assigns the same identifier (ID) to a piece of information common to the real space and the virtual space. The real-space information control system and the virtual-space information control system are connected, and the space-integration control system controls the real-space information control system and the virtual-space information control system in a coordinated fashion by using the same identifier.

Japanese Unexamined Patent Application Publication No. 2007-280157 discloses a three-dimensional-terrain model fabrication system that includes a developed-view creating unit for creating a two-dimensional developed view and a developed-view printing unit for printing the developed view on a sheet. The developed-view creating unit creates a two-dimensional developed view in accordance with a three-dimensional model in which textures are attached to building-like objects included in a three-dimensional form. The three-dimensional form represents a three-dimensional terrain defined by three-dimensional-terrain data. The building-like objects, to which the textures are attached in the three-dimensional model, can be built by using the two-dimensional developed view, and the three-dimensional outward appearances of the building-like objects can be formed.

### SUMMARY

Real space, virtual space, and space formed by combining real space and virtual space, which existed separately in the past, have begun to intrude into each other. This intrusion is made possible since it has become possible to cause changes to virtual space or add virtual-space objects to images captured in real space by using a device such as a smartphone. The use of information such as positional information of a smartphone has made such operations possible. If virtual space and real space can be associated with each other, exchanges of information between virtual space and real space can stimulate human thinking.

Aspects of non-limiting embodiments of the present disclosure relate to providing an information processing apparatus and a non-transitory computer readable medium storing a computer program that can establish association between virtual space and real space by using structured information in which pieces of information are structured.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to store three-dimensional data in association with structured information in which pieces of information are structured, the three-dimensional data enabling a three-dimensional object created in virtual space to be output as a three-dimensional object in real space, output the three-dimensional data, which is stored, to an apparatus in real space, the apparatus being capable of outputting the three-dimensional object in real space, acquire real-life data regarding the three-dimensional object in real space after the three-dimensional data is output to the apparatus, and incorporate the real-life data regarding the three-dimensional data into the structured information.

### BRIEF DESCRIPTION OF THE DRAWINGS

An exemplary embodiment of the present disclosure will be described in detail based on the following figures, wherein:

FIG. 1 is an illustration depicting a schematic configuration of an information processing system according to the present exemplary embodiment;

FIG. 2 is a block diagram depicting a hardware configuration of a server;

FIG. 3 is a block diagram depicting an example of a functional configuration of the server;

FIG. 4 is an illustration depicting an example of information stored in a memory;

FIG. 5 is a flowchart depicting a flow of an information construction process performed by the server;

FIG. 6 is an illustration depicting an example of a piece of structured information;

FIG. 7 is an illustration depicting an example of a piece of structured information; and

FIG. 8 is an illustration depicting an example of a piece of structured information.

### DETAILED DESCRIPTION

Hereinafter, an exemplary embodiment according to the present disclosure will be described with reference to the drawings. In the figures, the same or equivalent elements and parts are denoted by the same reference signs. The dimensions and proportions in the figures are emphasized for the sake of description and are not necessarily drawn to scale.

First, the background, which has led the present inventors to the exemplary embodiment of the present disclosure, will be described.

Human thinking proceeds as numerous events are systematized and the events are traced in accordance with the systematized arrangement. However, even if the same event is selected as the starting point, the events are usually traced differently by each person, who starts from the same event. In other words, numerous events are systematized based on a subjective point of view of each person, and thus the result of systematization can also vary depending on a person.

Physical objects that appear in real space do not represent the entire human thinking but represent only a fraction of the human thinking. To represent the human thinking, objects in virtual space existing in the human thinking are visualized by using techniques such as computer graphics and simulation. However, these techniques only visualize virtual-space objects virtually, and it has been difficult to represent virtual-space objects in real space.

In this way, real space, virtual space, and space formed by combining real space and virtual space, which existed separately in the past, have begun to intrude into each other. This intrusion is made possible since it has become possible to cause changes to virtual space or add virtual-space objects to images captured in real space by using a device such as a smartphone. The use of information such as positional information of a smartphone has made such operations possible. Furthermore, representing virtual-space objects, which are located in virtual space existing in human thinking, in the real world has become possible owing to the recent advent of a three-dimensional (3D) printer, which can form a three-dimensional object based on data.

Human thinking is materialized by representing virtual-space objects in real space, and the materialization is a result of tracing systematized events in accordance with the systematized arrangement. Real space, virtual space, and space formed by combining real space and virtual space intrude into each other, which also means that an entity existing in one world is defined and structured in another world or in both worlds. It is expected that people can acquire new awareness and can further proceed with the systemization of events by obtaining real-space information regarding objects represented in real space or by looking at human thinking materialized in real space.

Thus, in consideration of the circumstances described above, the present inventors have thoroughly studied techniques that can establish association between virtual space and real space by using structured information in which pieces of information are structured. As a result, as described below, the present inventors have devised a technique that uses structured information in which pieces of information are structured and that can establish association between virtual space and real space via objects that are output in real space.

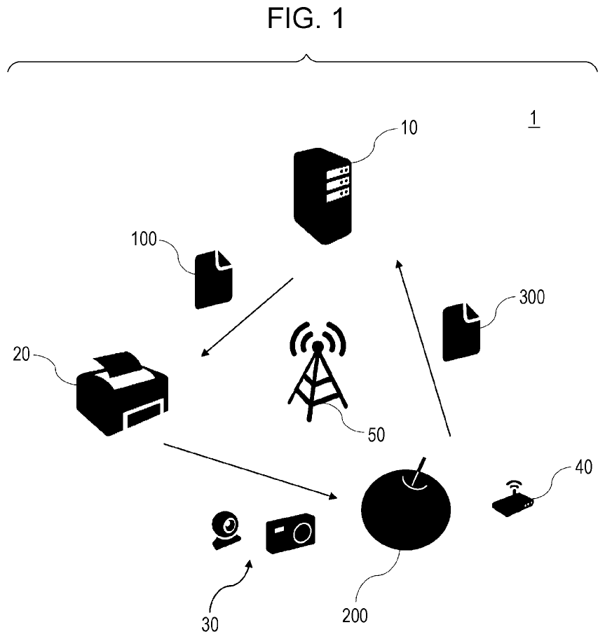

FIG. 1 is an illustration depicting a schematic configuration of an information processing system according to the present exemplary embodiment.

An information processing system 1 depicted in FIG. 1 has a configuration including a server 10, a 3D printer 20, a camera 30, and a sensor 40.

The server 10 is an example of an information processing apparatus according to the present disclosure. The server 10 is an apparatus that manages structured information in which contents are structured. In the present exemplary embodiment, a piece of structured information, whose specific examples will be described below, represents a piece of information in which relationships between contents are represented in a multifaceted manner. Contents managed by the server 10 in the present exemplary embodiment are virtual objects and can be output as a three-dimensional object by using the 3D printer 20. A user can access the server 10 and can reference or edit the contents managed by the server 10 by using a user terminal (not illustrated), such as a personal computer or a mobile terminal including a smartphone.

The server 10 can output 3D data 100 to the 3D printer 20, and the 3D data 100 enables a three-dimensional object to be output from the 3D printer 20. For example, the 3D data 100 may be data in the Extensible Markup Language (XML) format, in which a voxel is used as a unit element and the size and material of each element are specified to represent a three-dimensional body. Examples of such data include data in conformity with the “FAbricatable Voxel” (FAV) format, which is a data format for 3D printing. The FAV format is a data format for a 3D printer, and the data in the FAV format can retain complex three-dimensional information including the internal structure, colors, materials, and connection strength of a three-dimensional object. Obviously, the data format that can be used for 3D printing in the present disclosure is not limited to the FAV format. For example, a data format in which data representing a three-dimensional form is stored in a text format or in a binary format and a data format in which data representing a three-dimensional form is described in an XML format other than the FAV format are also usable in the present disclosure. Examples of the former include a data format such as the Standard Triangulated Language (STL) format, and examples of the latter include data formats such as the Additive Manufacturing File Format (AMF) and the 3D Manufacturing Format (3MT).

Only a single server is depicted as the server 10 in FIG. 1, but the present disclosure is not limited to this example. The information processing system 1 may include a plurality of servers, which are represented by the server 10.

The 3D printer 20 outputs a three-dimensional object 200 in accordance with the 3D data 100. In the example depicted in FIG. 1, an apple is illustrated as the three-dimensional object 200.

The place where the 3D printer 20 is located is not limited to a specific place as long as the 3D printer 20 can be connected to the server 10. Accordingly, the information processing system 1 according to the present exemplary embodiment is capable of outputting the three-dimensional object 200 from the 3D printer 20 located in any place. Further, the information processing system 1 according to the present exemplary embodiment is capable of outputting an object from the 3D printer 20 by using the 3D data 100, which is created by other people, as long as the 3D data 100 is available.

The camera 30 and the sensor 40 are devices for acquiring real-life data 300 of the three-dimensional object 200 in real space. The camera 30 and the sensor 40 acquire pieces of data such as a date and time, shape, color, internal structure, hardness, temperature, humidity, smell, and a location of output as the real-life data 300 of the three-dimensional object 200 in real space. The real-life data 300 acquired by the camera 30 and the sensor 40 is sent to the server 10. The server 10 acquires the real-life data 300 of an object in real space for which the 3D data 100 has been output to the 3D printer 20, and thus can continue to improve the content of the virtual object managed by the server 10.

The server 10 may use the real-life data 300, which is acquired by the camera 30 and the sensor 40, for example, to uniquely identify the three-dimensional object 200 by using the technology for recognition of unique objects. The server 10 uses the real-life data 300, which is acquired by the camera 30 and the sensor 40, to uniquely identify the three-dimensional object 200, and thus a surface image of an object that has been output as the three-dimensional object 200 in real space can be retained in association with the real-life data 300. Since the object that has been output as the three-dimensional object 200 in real life is retained in association with the real-life data 300, an information-exchange type system can be constructed based on the structure of the 3D data 100 and the structure of the real-life data 300.

All the devices in the information processing system 1 are connected to each other by using a network 50. The authenticity of information that is output from each device may be ensured, for example, by using the blockchain technology.

Next, a hardware configuration of the server 10 will be described.

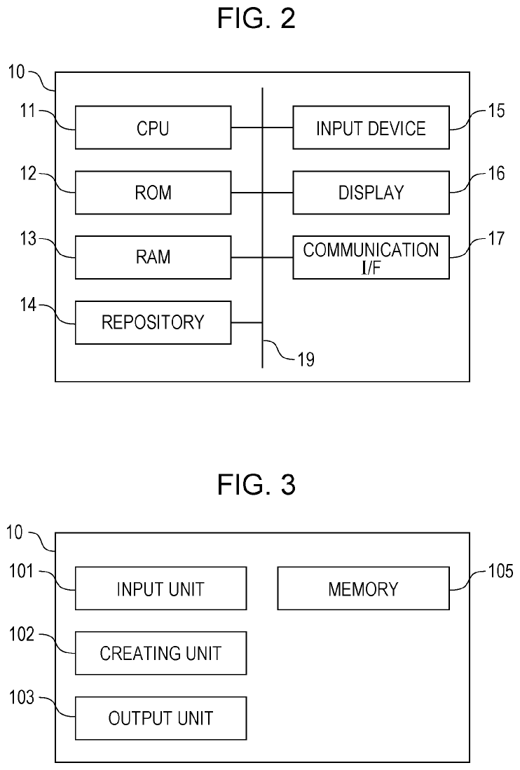

FIG. 2 is a block diagram depicting the hardware configuration of the server 10.

As depicted in FIG. 2, the server 10 includes a central processing unit (CPU) 11, a read-only memory (ROM) 12, a random-access memory (RAM) 13, a repository 14, an input device 15, a display 16, and a communication interface (I/F) 17. These units are communicatively connected to each other by using a bus 19.

The CPU 11, which is a central computing processing unit, executes various programs and controls each unit. Specifically, the CPU 11 loads programs from the ROM 12 or from the repository 14 and uses the RAM 13 as a working space to execute the programs. The CPU 11 controls each unit described above and performs various kinds of computing processing in accordance with the programs recorded on the ROM 12 or on the repository 14. In the present exemplary embodiment, an information construction program is stored in the ROM 12 or in the repository 14, and the information construction program not only creates and outputs the 3D data 100 but also acquires the real-life data 300 and incorporates the real-life data 300 into the structured information.

The ROM 12 stores various programs and various kinds of data. The RAM 13 temporarily retains programs or data as the working space. A storage device such as a hard disk drive (HDD), a solid state drive (SSD), or a flash memory constitutes the repository 14, which stores various programs including the operating system and various kinds of data.

The input device 15 includes a pointing device, such as a mouse, and a keyboard and is used for receiving various kinds of input.

The display 16 is, for example, a liquid crystal display and displays various kinds of information. A touch panel system may be adopted as the display 16 and may also function as the input device 15.

The communication interface 17 is an interface for communicating with other apparatuses, such as the 3D printer 20, and such a standard as the Ethernet (registered trademark), fiber distributed data interface (FDDI), or Wi-Fi (registered trademark) is used.

While executing the information construction program above, the server 10 uses the hardware resource described above and realizes various functions. A functional configuration realized by the server 10 will be described.

FIG. 3 is a block diagram depicting an example of the functional configuration of the server 10.

As depicted in FIG. 3, the server 10 includes an input unit 101, a creating unit 102, an output unit 103, and a memory 105 as functional sections. Each functional section is realized by the CPU 11, which loads and executes the information construction program stored in the ROM 12 or in the repository 14.

The input unit 101 receives input regarding creation of a three-dimensional object in virtual space from the user terminal (not illustrated). Examples of input regarding creation of a three-dimensional object include input regarding an arrangement of voxels. The arrangement of voxels constitutes a basis for a three-dimensional object. A piece of structured information formed by the user constitutes a basis for a three-dimensional object. Examples of pieces of structured information will be described below.

The input unit 101 also receives input regarding structured information from the user terminal.

In addition, the input unit 101 receives the real-life data 300 of the three-dimensional object 200 in real space. The real-life data 300 is acquired by the camera 30 and the sensor 40.

The creating unit 102 creates a three-dimensional object in accordance with input received from the user terminal regarding creation of a three-dimensional object in virtual space. The creating unit 102 creates a three-dimensional object by using voxels as unit elements.

The creating unit 102 also creates the 3D data 100, which enables a three-dimensional object created by the user in virtual space to be output from the 3D printer 20. For example, the creating unit 102 creates the 3D data 100 in the XML format, in which a voxel is used as a unit element and the size and material of each element are specified to represent a three-dimensional body.

In addition, the creating unit 102 uses the real-life data 300 of the three-dimensional object 200 in real space and creates a piece of structured information in accordance with a user operation.

The output unit 103 presents a piece of structured information to the user terminal in accordance with input from the user terminal regarding the presentation of structured information in virtual space. When presenting the piece of structured information to the user terminal, the output unit 103 may present the content of a piece of structured information of another user at a related position of the piece of structured information of the user.

The output unit 103 also presents to the user terminal a three-dimensional object created based on input received from the user terminal regarding creation of the three-dimensional object in virtual space. In addition, the output unit 103 outputs the 3D data 100, which is created by the creating unit 102, to the 3D printer 20.

The memory 105 is disposed, for example, in the repository 14 and stores various kinds of information regarding operations of the server 10. In the present exemplary embodiment, the memory 105 stores information regarding structured information as an example of the various kinds of information regarding operations of the server 10. The information regarding structured information includes a data structure to create the structured information. The memory 105 also stores information regarding a three-dimensional object, the 3D data 100 regarding the three-dimensional object, and the real-life data 300.

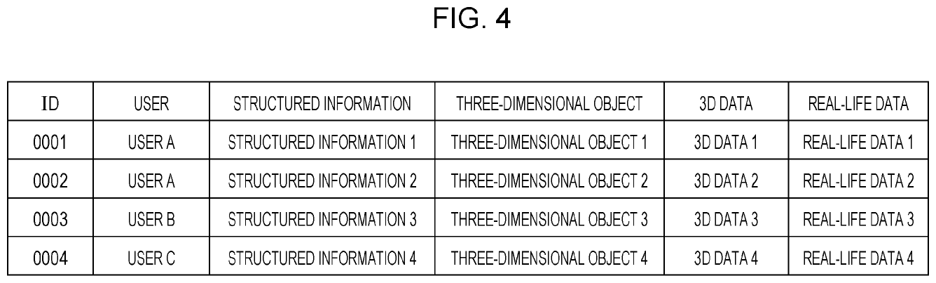

FIG. 4 is an illustration depicting an example of information stored in the memory 105. In FIG. 4, an example is depicted in which various kinds of data are managed by using a single ID, the various kinds of data being a user who has created a piece of structured information, data regarding the piece of structured information, data regarding a three-dimensional object, 3D data regarding the three-dimensional object, and real-life data regarding the three-dimensional object. In each column, a single kind of data is stored in the binary format.

Examples of information stored in the memory 105 are not limited to the one depicted in FIG. 4. Further, a data structure for a piece of structured information, a data structure for a three-dimensional object, a data structure for 3D data, and a data structure for real-life data are not limited to a specific structure.

Since the server 10 according to the present exemplary embodiment has the configuration described above, the server 10 can cause the 3D printer 20 to create in real space a three-dimensional object, which has been created in virtual space by the user in accordance with a piece of structured information. In addition, since the server 10 according to the present exemplary embodiment has the configuration described above, the server 10 can acquire the real-life data 300 of the three-dimensional object 200 in real space, which has been created in real space by the 3D printer 20. Further, since the server 10 according to the present exemplary embodiment has the configuration described above, the server 10 can incorporate the real-life data 300 of the three-dimensional object 200 in real space into the piece of structured information.

Next, an operation of the server 10 will be described.

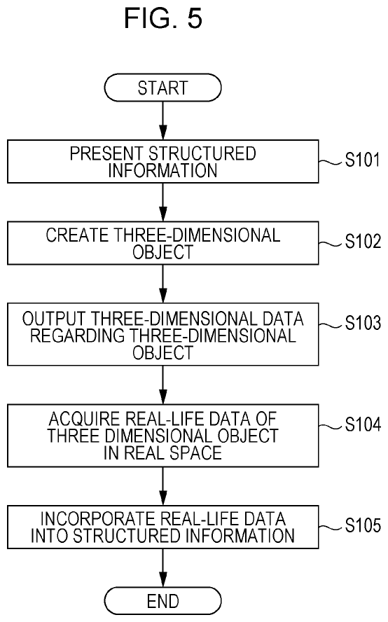

FIG. 5 is a flowchart depicting a flow of an information construction process performed by the server 10. The CPU 11 reads the information construction program stored in the ROM 12 or in the repository 14 and loads the information construction program onto the RAM 13 to execute the program, and then the information construction process is performed.

The CPU 11 presents structured information stored in the repository 14 to the user terminal connected to the server 10 (step S101). Examples of pieces of structured information will be described below.

Following step S101, the CPU 11 creates a three-dimensional object in virtual space in accordance with an operation by the user, who has referenced a piece of structured information (step S102).

Following step S102, the CPU 11 creates the 3D data 100 to output in real space the three-dimensional object created in virtual space (step S103). The CPU 11 may create the 3D data 100 in the XML format, in which the size and material of each element are specified to represent a three-dimensional body.

Following step S103, the CPU 11 acquires the real-life data 300 of the three-dimensional object 200 in real space, which has been output in real space from the 3D printer 20 in accordance with the 3D data 100 (step S104).

Following step S104, the CPU 11 incorporates the real-life data 300, which has been acquired, into the piece of structured information (step S105). The CPU 11 causes the repository 14 to store the piece of structured information, into which the real-life data 300 has been incorporated.

Since the server 10 according to the present exemplary embodiment performs the operation described above, the server 10 can cause the 3D printer 20 to create in real space a three-dimensional object, which has been created in virtual space by the user in accordance with a piece of structured information. In addition, since the server 10 according to the present exemplary embodiment performs the operation described above, the server 10 can acquire the real-life data 300 of the three-dimensional object 200 in real space, which has been created in real space by the 3D printer 20. Further, since the server 10 according to the present exemplary embodiment performs the operation described above, the server 10 can incorporate the real-life data 300 into the piece of structured information.

A specific example of the operation of the server 10 according to the present exemplary embodiment will be described.

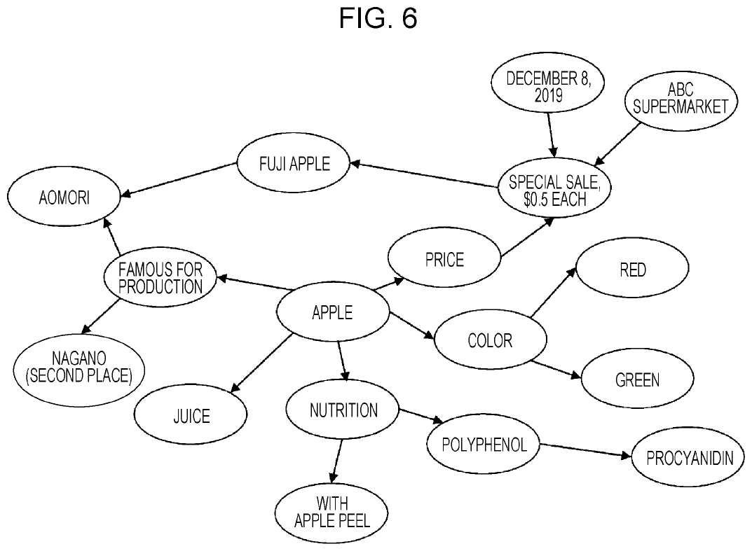

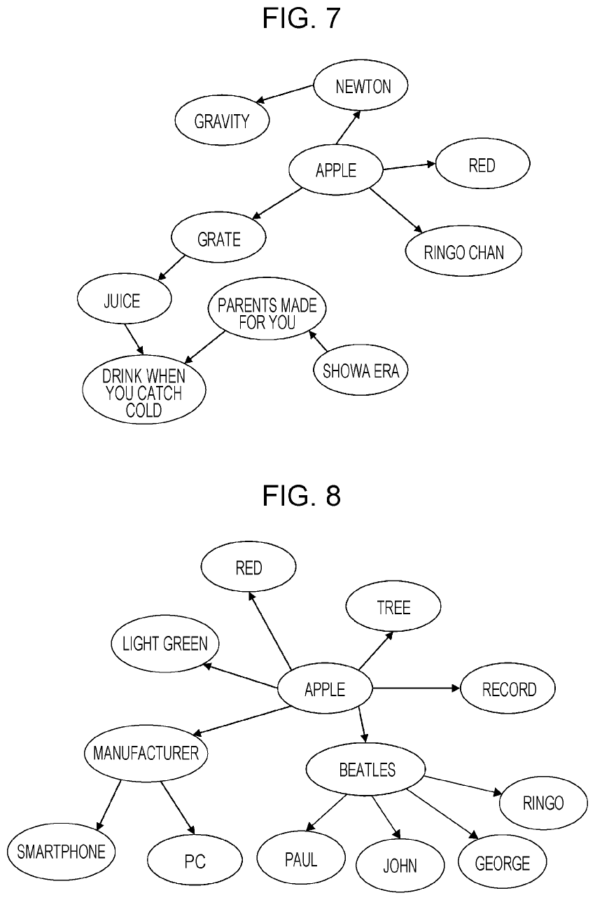

In this example, a description will be given of the case where information is structured around a word “APPLE”. Even with the word “APPLE”, information is structured in a plurality of patterns. FIGS. 6 to 8 each illustrate an example of a piece of structured information, which is structured around the word “APPLE”. FIG. 6 illustrates an example of a piece of structured information, which is created by a user A around the item “APPLE”. FIG. 7 illustrates an example of a piece of structured information, which is created by a user B around the item “APPLE”. FIG. 8 illustrates an example of a piece of structured information, which is created by a user C around the item “APPLE”. In each piece of structured information, an arrow represents a parent-child relationship. In addition, each piece of structured information is created subjectively by a user and stored in the memory 105 so that a user who has created each piece of structured information is recognizable.

In this way, even with the word “APPLE”, the pattern of structuring differs greatly for each user. Specifically, the information structured around the word “APPLE” contains wide-ranging contents, and a variety of output items are created around the word “APPLE”. The server 10 incorporates such pieces of structured information as are depicted in FIGS. 6 to 8 into the 3D data 100 as attribute information, and thus the three-dimensional object 200 can be obtained in accordance with the pieces of structured information.

Using the information processing system 1 according to the present exemplary embodiment, a user references a three-dimensional object created based on a piece of structured information of another user, and thus the user can determine whether to apply the obtained information to the piece of structured information of the user. For example, since the word “APPLE” evokes a word “JUICE” for the user A and the relationship is structured by the user A, the server 10 may present an arrow linking the word “APPLE” to the word “JUICE” in the piece of structured information of the user C, which is depicted in FIG. 8.

A case where a user creates an apple as a three-dimensional object will be described as an example. Looking at the apple created by the user, another user can determine whether to apply the information obtained from the apple to a piece of structured information regarding an apple or to a piece of structured information regarding a fruit other than an apple, a vegetable, or the like.

Obviously, structured information is not limited to objects related to fruits, vegetables, or other foods. For example, if information is structured around a word “AUTOMOBILE”, a user may structure the information with respect to various components to be used in an automobile, and another user may structure information with respect to impressions evoked by an automobile. If a component used in an automobile is output as the three-dimensional object 200, the server 10 incorporates the real-life data regarding the component into a piece of structured information and thus enables each user to determine whether to apply the information obtained from the component to a piece of structured information of each user.

In addition, the server 10 according to the present exemplary embodiment presents a piece of structured information to the user terminal in accordance with input from the user terminal regarding the presentation of structured information in virtual space. At that time, the server 10 may provide presentation such that a structure involving an element in a piece of structured information created by a user is incorporated into a different piece of structured information created by another user.

Further, the information processing system 1 according to the present exemplary embodiment acquires the real-life data 300 of the three-dimensional object 200, which is output in accordance with a piece of structured information, and thus can realize improvement of the three-dimensional object or fabrication of a substitute.

For example, the three-dimensional object 200 depicted in FIG. 1 is an apple. The 3D printer 20 outputs the apple at a certain location and in a certain circumstance. The surface of the apple is captured by the camera 30 or measured by the sensor 40 to obtain the real-life data 300, which is stored by the server 10. In the event of a trouble with the apple, which has been output, the reason for the trouble can be traced by referencing the real-life data 300. Further, in the event of a trouble with the apple, which has been output, a substitute part or the entire body that has texture similar to the original texture of the apple is output from the 3D printer 20, and thus the apple, which has been output, can be re-formed.

For example, even if the initial state of the three-dimensional object 200, which has been output, is the same, the state of the three-dimensional object 200 can vary thereafter depending on a location in which the three-dimensional object 200 has been output. If the state of the three-dimensional object 200 does not change in a cold environment, the state of the three-dimensional object 200 may change in a hot environment. The server 10 can acquire the real-life data 300 of each three-dimensional object having the same initial state and can incorporate into a corresponding piece of structured information the real-life data 300 acquired in the location in which each three-dimensional object has been output.

The server 10 may also retain in the memory 105 a reason for a breakdown or corrosion of the three-dimensional object 200, which has been output from the 3D printer 20, in association with the three-dimensional object 200. The server 10 may also retain in the memory 105 another version of the 3D data 100, which is obtained by improving the three-dimensional object 200, in association with the three-dimensional object 200. The server 10 may also add as an element of a piece of structured information the reason for a breakdown or corrosion of the three-dimensional object 200, which has been output from the 3D printer 20.

The server 10 may also acquire as the real-life data 300 the history information regarding a breakdown or corrosion of the three-dimensional object 200, which has been output from the 3D printer 20. Acquisition of such history information as is described above enables the server 10 to grasp the time at which the breakdown or corrosion of the three-dimensional object 200 occurred. The server 10 may also acquire as the real-life data 300 the history information regarding one or more repairs of the three-dimensional object 200, which has been output from the 3D printer 20. Acquisition of such history information as is described above enables the server 10 to grasp the time at which the one or more repairs of the three-dimensional object 200 were performed. The acquisition of such history information as is described above by the server 10 enables each user to improve the three-dimensional object 200.

In this way, the information processing system 1 according to the present exemplary embodiment can output in real space a three-dimensional object created in virtual space in accordance with a piece of structured information representing human thinking. Further, the information processing system 1 according to the present exemplary embodiment can incorporate real-life data of the three-dimensional object, which has been output in real space, into the piece of structured information. The information processing system 1 according to the present exemplary embodiment exchanges information between virtual space and real space, and thus a user can visualize thinking and incorporate the content of thinking of other people into the thinking of the user.

In the exemplary embodiment described above, the CPU loads software (a program) and executes the information construction process, but the information construction process may be executed by various processors other than the CPU. Examples of such a processor include a programmable logic device (PLD), such as a field-programmable gate array (FPGA), whose circuit configuration is modifiable after fabrication, and a dedicated electric circuit, such as an application-specific integrated circuit (ASIC), which is a processor having a circuit configuration exclusively designed to execute a specific process. Further, the information construction process may be performed by one of the various processors described above or by a combination of two or more similar or dissimilar processors (for example, a combination of a plurality of FPGAs or a combination of a CPU and an FPGA). More specifically, the hardware structure of these various processors is an electric circuit formed by a combination of circuit elements such as semiconductor devices.

Further, in the above exemplary embodiment, a case where the program for the information construction process is stored (installed) in the ROM or in the repository in advance has been described by way of non-limiting example. The program may be recorded on a non-transitory recording medium and provided. Examples of the non-transitory recording medium include a compact disc read-only memory (CD-ROM), a digital versatile disc read-only memory (DVD-ROM), and a universal serial bus (USB) memory. Alternatively, the program may be downloaded from an external apparatus via a network.

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
store three-dimensional data in association with structured information in which pieces of information are structured, the three-dimensional data enabling a three-dimensional object created in virtual space to be output as a three-dimensional object in real space,
output the three-dimensional data, which is stored, to an apparatus in real space, the apparatus being capable of outputting the three-dimensional object in real space,
acquire real-life data regarding the three-dimensional object in real space after the three-dimensional data is output to the apparatus, and
incorporate the real-life data regarding the three-dimensional data into the structured information.

2. The information processing apparatus according to claim 1,
wherein the processor is configured to acquire, as the real-life data, data obtained by sensing the three-dimensional object in real space.

3. The information processing apparatus according to claim 2,
wherein the processor is configured to update the structured information in accordance with the real-life data, which has been acquired, the structured information being associated with the three-dimensional data, which is original data.

4. The information processing apparatus according to claim 2,
wherein the processor is configured to acquire, as the real-life data, data obtained by nondestructively measuring the three-dimensional object in real space.

5. The information processing apparatus according to claim 1,
wherein the processor is configured to acquire, as the real-life data, an image that captures at least a portion of the three-dimensional object in real space.

6. The information processing apparatus according to claim 5,
wherein the processor is configured to acquire, as the real-life data, information regarding a result of comparison with the image.

7. The information processing apparatus according to claim 1,
wherein the processor is configured to manage the structured information for each user.

8. The information processing apparatus according to claim 7,
wherein the processor is configured to present content of the structured information of one user at a related position of the structured information of another user.

9. The information processing apparatus according to claim 1,
wherein the processor is configured to output the three-dimensional data in a markup language format.

10. The information processing apparatus according to claim 9,
wherein the processor is configured to output the three-dimensional data in the markup language format and one or more features are described by using voxels as unit elements in the markup language format.

11. A non-transitory computer readable medium storing a program causing a computer to execute a process for information processing, the process comprising:
storing three-dimensional data in association with structured information in which pieces of information are structured, the three-dimensional data enabling a three-dimensional object created in virtual space to be output as a three-dimensional object in real space;
outputting the three-dimensional data, which is stored, to an apparatus in real space, the apparatus being capable of outputting the three-dimensional object in real space;
acquiring real-life data regarding the three-dimensional object in real space after the three-dimensional data is output to the apparatus; and
incorporating the real-life data regarding the three-dimensional data into the structured information.

12. An information processing apparatus comprising:
means for storing three-dimensional data in association with structured information in which pieces of information are structured, the three-dimensional data enabling a three-dimensional object created in virtual space to be output as a three-dimensional object in real space;
means for outputting the three-dimensional data, which is stored, to an apparatus in real space, the apparatus being capable of outputting the three-dimensional object in real space;
means for acquiring real-life data regarding the three-dimensional object in real space after the three-dimensional data is output to the apparatus; and
means for incorporating the real-life data regarding the three-dimensional data into the structured information.
